(19) United States
(12) Patent Application Publication
(10) Pub. No.: US 2025/0123426 A1
(43) Pub. Date: Apr. 17, 2025

(54) MICROLENS ARRAY FOR OBTAINING MULTI-FOCUS PLENOPTIC IMAGE AND METHOD OF MANUFACTURING THE SAME

(71) Applicant: Electronics and Telecommunications Research Institute, Daejeon (KR)

(72) Inventors: Mun Seob LEE, Daejeon (KR); Chihoon KIM, Daejeon (KR)

(73) Assignee: Electronics and Telecommunications Research Institute, Daejeon (KR)

(21) Appl. No.: 18/912,764

(22) Filed: Oct. 11, 2024

(30) Foreign Application Priority Data
Oct. 13, 2023 (KR) 10-2023-0136599
Sep. 30, 2024 (KR) 10-2024-0132628

(51) Int. Cl. G02B 3/00; H04N 23/957

(52) U.S. Cl. CPC G02B 3/0043; G02B 3/0031; G02B 3/0062; H04N 23/957

(57) ABSTRACT

A microlens array for obtaining a multi-focus plenoptic image includes a first individual microlens array where first microlenses having one focus distance are arranged on a first substrate, a second individual microlens array where second microlenses having the same or different focus distances are arranged on a second substrate, the second individual microlens array being stacked on the first individual microlens array having the same or different focus distances, and a third individual microlens array where third microlenses having the same or different focus distances are arranged on a third substrate, the third individual microlens array being stacked on the second individual microlens array. As seen in a plane, an array form of the first to third microlenses are configured with two microlenses, which are spaced apart from each other by an interval corresponding to one microlens in a vertical axis and a horizontal axis, on one of the first to third substrates.

### CROSS-REFERENCE TO RELATED APPLICATIONS

This application claims the benefit of the Korean Patent Application Nos. 10-2023-0136599 filed on Oct. 13, 2023 and 10-2024-0132628 filed on Sep. 30, 2024, which is hereby incorporated by reference as if fully set forth herein.

### BACKGROUND

### Field of the Invention

The present disclosure relates to plenoptic technology, and more particularly, to a microlens array for obtaining a multi-focus plenoptic image, which may include a configuration for effectively obtaining position information about a space region and direction information about each region, and a method of manufacturing the microlens array.

### Discussion of the Related Art

Plenoptic or light-field image technology is technology which obtains 4D (x, y, θ, φ) light-field information about emitted light in an object or a scene, based on a microlens array (MLA).

Plenoptic technology records light emitted from an object by using one image sensor and a lens array or a camera array where focuses or positions differ.

That is, a three-dimensional (3D) image of an object may be obtained by recording images in different directions in the object, and thus, an image corresponding to an arbitrary time or focus may be configured.

Representative examples of plenoptic cameras, which obtain images at different viewpoints by using one sensor including a microlens array, include a plenoptic camera prototype system implemented by Ng, Adelson of Standford University in 2005.

Microlens arrays are provided in a form where lenses having a micrometer size are arranged and have a high lens curvature and a short valid focus distance, and thus, have an advantage where a small size and a wide view of field (FOV) are secured.

Based on such an advantage, microlens arrays are being used in various fields such as 3D imaging, security cameras, computer holograms, and a complex eye system.

Particularly, a parallax of an object is calculated based on a light path difference between the object and a sensor by using a microlens array, and thus, plenoptic technology for obtaining 3D information about an object is being applied to various fields such as a medical image system, a machine vision, national defense field, and obtainment of cultural assets.

Recently, multi-focus plenoptic camera technology illustrated in FIG. 1 has been proposed.

The multi-focus plenoptic camera technology is technology where a microlens array 10 where microlenses having different focus distances are arranged is disposed on a phase surface of a main lens 30 to increase a depth of focus (DoF) and enhance a depth resolution.

However, in this case, because the microlens array 10 should be manufactured by arranging microlenses having different focus distances, a level of process difficulty is high, and a yield rate is low.

Particular, in a multi-focus plenoptic camera where the microlens array having different focus distances illustrated in FIG. 1 is applied to one substrate, the dimension or refraction surface distortion of the microlens decreases a resolution of each image 50, and due to this, it is difficult to recover each image 50.

For this reason, it is required to develop a method which reduces a level of process difficulty, increases a yield rate, increases a dimension of a microlens or a resolution of an image, and enables each image to be easily recovered. However, a satisfied result is not yet obtained to date.

### SUMMARY

An aspect of the present disclosure is directed to providing a microlens array for obtaining a multi-focus plenoptic image and a method of manufacturing the microlens array, which may reduce a level of process difficulty, increase a yield rate, increase a dimension of a microlens or a resolution of an image, and enable an image to be easily recovered.

The advantages, features and aspects of the present invention will become apparent from the following description of the embodiments with reference to the accompanying drawings, which is set forth hereinafter.

To achieve these and other advantages and in accordance with the purpose of the invention, as embodied and broadly described herein, there is provided a microlens array for obtaining a multi-focus plenoptic image, the microlens array including: a first individual microlens array where first microlenses having one focus distance are arranged on a first substrate; a second individual microlens array where second microlenses having the same or different focus distances are arranged on a second substrate, the second individual microlens array being stacked on the first individual microlens array; and a third individual microlens array where third microlenses having the same or different focus distances are arranged on a third substrate, the third individual microlens array being stacked on the second individual microlens array, wherein, as seen in a plane, an array form of the first to third microlenses are configured with two microlenses, which are spaced apart from each other by an interval corresponding to one microlens in a vertical axis and a horizontal axis, on one of the first to third substrates.

The second individual microlens array may be phase-shifted by a diameter of a microlens in one direction of a vertical direction and a horizontal direction.

The microlens array may further include an n^{th} individual microlens array where n^{th} microlenses having the same focus distance are arranged on an n^{th} substrate, the n^{th} individual microlens array being stacked on the first to third individual microlens arrays.

The focus distances of the first to third microlenses may differ.

The focus distances of the first to third microlenses may be equal to one another.

A coating surface may be provided in at least one of the first to third individual microlens arrays.

In another aspect of the present invention, there is provided a method of manufacturing a microlens array for obtaining a multi-focus plenoptic image, the method including: a step of forming a first microlens having a first focus distance on a first substrate to manufacture a first individual microlens array; a step of forming a second microlens having a second focus distance on a second substrate to manufacture a second individual microlens array; a step of forming a third microlens having a third focus distance on a third substrate to manufacture a third individual microlens array; and a step of stacking the first to third individual microlens arrays.

The first to third individual microlens arrays may be manufactured by a nano imprinting process.

The method may further include: a step of forming an n^{th} microlens having an n^{th} focus distance on an n^{th} substrate to manufacture an n^{th} individual microlens array; and a step of stacking the n^{th} individual microlens array on the first to third individual microlens arrays.

The focus distances of the first to third microlenses may differ.

The focus distances of the first to third microlenses may be equal to one another.

Array forms of first to third microlenses respectively arranged in the first to third individual microlens arrays may be equal to one another.

The method may further include a step of forming a coating surface in at least one of the first to third individual microlens arrays.

In another aspect of the present invention, there is provided a multi-focus plenoptic image obtaining device including: a main lens configured to collect light from an object; an image sensor configured to perform imaging of the light collected by the main lens; a first individual microlens array where a first microlens having a first focus distance is arranged, the first individual microlens array being disposed between the main lens and the image sensor; a second individual microlens array where a second microlens having a second focus distance is arranged, the second individual microlens array being stacked on the first individual microlens array; and a third individual microlens array where a third microlens having a third focus distance is arranged, the third individual microlens array being stacked on the second individual microlens array, wherein a microlens array including the first to third individual microlens arrays transfers the light, collected by the main lens, to the image sensor at a plurality of different focus distances.

The microlens array may further include an n^{th} individual microlens array where n^{th} microlenses having the same focus distance are arranged on an n^{th} substrate, the n^{th} individual microlens array being stacked on the first to third individual microlens arrays.

According to an embodiment of the present invention, unlike the related art, a plenoptic camera based on a microlens array for effectively enhancing an image resolution and a space image resolution in each direction may be implemented.

Comparing with a conventional method, in embodiments of the present invention, a manufacturing process may be simplified and enhanced in convenience, the accuracy of a microlens array may be enhanced, and a resolution of a plenoptic image may be improved.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a schematical configuration diagram of a multi-focus plenoptic camera (application of a multi-focus MLA).

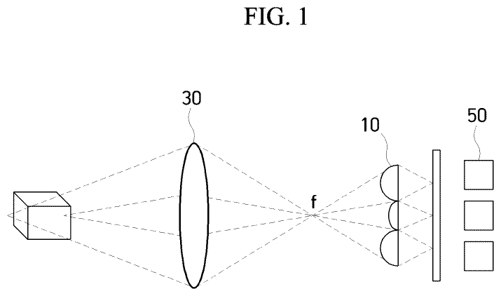

FIG. 2 is a schematical cross-sectional view for describing a general microlens array.

FIG. 3 is a plan view illustrating a plane of a microlens array according to an embodiment of the present invention.

FIG. 4 is a cross-sectional view of a microlens array according to an embodiment for describing a concept of the present invention.

FIG. 5 is a cross-sectional view of a microlens array according to an embodiment of the present invention.

FIG. 6 is an exemplary diagram of a microlens array form of an individual microlens array configuring a microlens array according to another embodiment of the present invention.

FIG. 7 is a diagram illustrating an example where a stack-type microlens array according to an embodiment of the present invention is applied to a plenoptic camera.

FIG. 8 is a flowchart illustrating a method of manufacturing a microlens array according to an embodiment of the present invention.

FIG. 9 is a schematic view illustrating an imprinting-based manufacturing process of a microlens array according to an embodiment of the present invention.

### DETAILED DESCRIPTION OF THE INVENTION

Hereinafter, embodiments of the present invention will be described in detail to be easily embodied by those skilled in the art with reference to the accompanying drawings. The present invention may, however, be embodied in many different forms and should not be construed as being limited to the embodiments set forth herein. The present invention may, however, be embodied in many different forms and should not be construed as being limited to the embodiments set forth herein. In the accompanying drawings, a portion irrelevant to a description of the present invention will be omitted for clarity. Like reference numerals refer to like elements throughout. Also, in providing description with reference to the drawings, although elements are represented by the same name, reference numeral referring to the elements may be changed, and reference numerals are merely described for convenience of description. It should not be construed that concepts, features, functions, or effects of elements are limited by reference numerals.

In the following description, the technical terms are used only for explaining a specific exemplary embodiment while not limiting the present invention. The terms of a singular form may include plural forms unless referred to the contrary.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

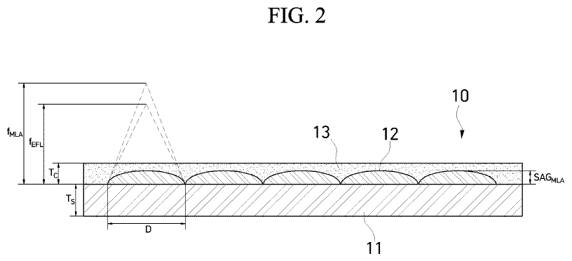

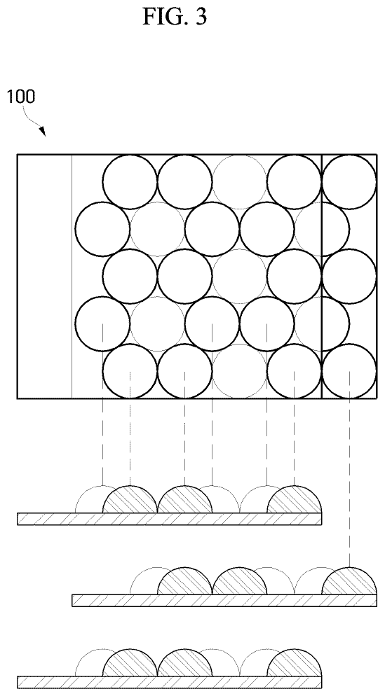

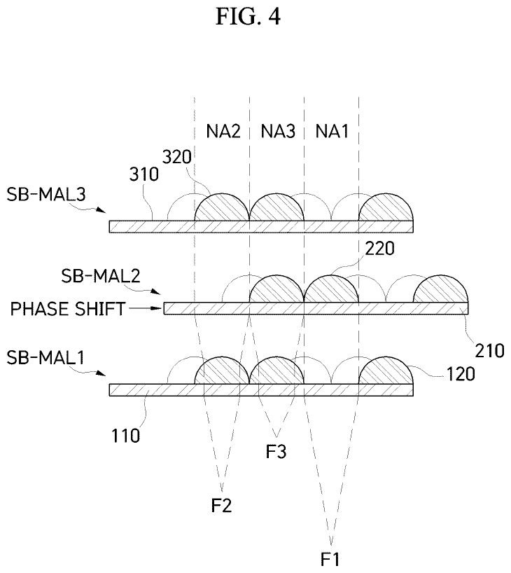

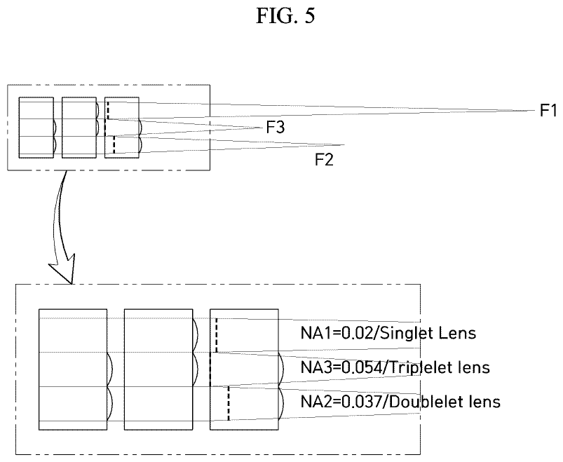

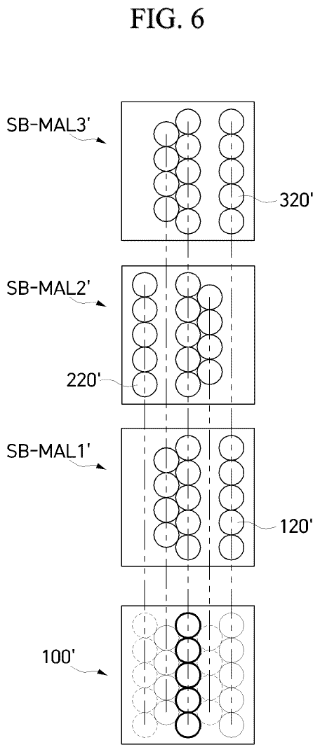

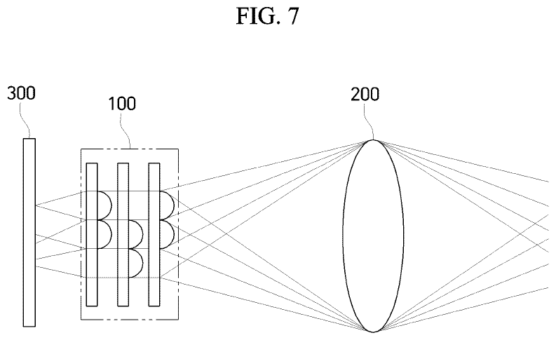

FIG. 2 is a schematical cross-sectional view for describing a general microlens array. FIG. 3 is a plan view illustrating a plane of a microlens array according to an embodiment of the present invention. FIG. 4 is a cross-sectional view of a microlens array according to an embodiment for describing a concept of the present invention. FIG. 5 is a cross-sectional view of a microlens array according to an embodiment of the present invention. FIG. 6 is an exemplary diagram of a microlens array form of an individual microlens array configuring a microlens array according to another embodiment of the present invention. FIG. 7 is a diagram illustrating an example where a stack-type microlens array according to an embodiment of the present invention is applied to a plenoptic camera.

FIG. 2 illustrates a configuration of a general microlens array 10.

The microlens array 10 has a form where microlenses are arranged on a substrate.

The microlens array 10 may be manufactured by various methods such as a lithography process, a photolithography process, an ultraviolet (UV) lithography process, a laser direct lithography process, an overcast process, a replica molding process, and an imprinting process and may be formed of various materials such as silica or a polymer.

A microlens array may be manufactured in a tetragonal shape as well as a circular shape, so as to maximally reflect a fill-factor on a substrate, and for example, may be variously manufactured in a hexagonal array form (an array where a figure connecting centers of microlenses with each other has a honeycomb structure) or a rectangular array form (an array where a figure connecting centers of microlenses with each other in a tetragonal shape has a lattice structure).

Based on a design, microlenses 12 may be arranged on a substrate 11, and then, a coating surface 13 may be formed of a material having a refractive index which differs from that of a material of the microlens 12, so as to adjust a focus distance.

The coating surface 13 may be used for varying a refractive index, or may not be used based on a use environment.

Moreover, in a hexagonal array form, a microlens array may be arranged so that a fill-factor is at a level of about 98%, and in a rectangular array form, a microlens array may be arranged so that a fill-factor is at a level of about 95%.

Therefore, generally, a hexagonal array form having a level of 98% may have an advantage which is higher in image resolution than a rectangular array form having a level of 98%.

An equation having a focus distance in a lens may be as follows.

Herein, F may denote a focus distance, n may denote a refractive index, and ROC=(h²+r²/2h) may denote a radius of curvature.

When a diameter is 200 um and focus distances are differently set, heights of resists may respectively be 1.99 um, and 3.99 um, and 6.01 um.

$$F = ROC / ( n - 1 ) \\ NA = n sin θ = n \frac{D}{F}$$

For example, when a diameter is 200 μm and focus distances are 1.6 mm, 2.5 mm, and 5.0 mm (corresponding to 0.18, 0.12, and 0.06 when NA), heights of microlens arrays may respectively be 1.99 um, 3.99 um, and 6.01 um.

However, a process of manufacturing microlens arrays having different heights on the same substrate should undergo a complicated process, and in some photolithography processes, difficulty in align occurs.

FIG. 3 is a plan view illustrating a plane of a microlens array 100 according to an embodiment of the present invention.

Referring to FIG. 3, the microlens array 100 may include a first individual microlens array SB-MLA1, a second individual microlens array SB-MLA2, and a third individual microlens array SB-MLA3.

The first individual microlens array SB-MLA1 may include a plurality of first microlenses 120 which have a first focus distance and are arranged on a first substrate 110.

Moreover, the second individual microlens array SB-MLA2 may be stacked on the first individual microlens array SB-MLA1 and may include a plurality of second microlenses 220 which have a second focus distance and are arranged on a second substrate 210.

Moreover, the third individual microlens array SB-MLA3 may be stacked on the second individual microlens array SB-MLA2 and may include a plurality of third microlenses 320 which have a third focus distance and are arranged on a third substrate 310.

As seen in a plane, the first to third individual microlens arrays SB-MLA1 to SB-MLA3 may be arranged in a form where two of the microlenses 120, 220, and 320 apart from each other by an interval corresponding to one of the microlenses 120, 220, and 320 in a vertical/horizontal axis are configured as one pair.

Each of the first to third individual microlens arrays SB-MLA1 to SB-MLA3 having such a form according to the present invention may be referred to as a skip-bound MLA.

The first to third individual microlens arrays SB-MLA1 to SB-MLA3 may be equal to one another, and thus, may be manufactured based on one mold.

Moreover, the microlenses 120, 220, and 320 respectively arranged on the first to third substrates 110, 210, and 310 and may be respectively manufactured on the first to third substrates 110, 210, and 310 through a series of manufacturing process.

Moreover, a plurality of skip-bound microlens arrays SB-MLA may have the same opening number NA and the same focus distance F #.

Furthermore, the first to third focus distances may differ or may be equal to one another.

Hereinafter, the principle of a stacked skip-bound microlens array SB-MLA according to the present invention will be described with reference to the drawing.

FIG. 4 is a cross-sectional view of a microlens array 100 according to an embodiment for describing a concept of the present invention.

Referring to FIG. 4, by stacking a first individual microlens array SB-MLA1, a second individual microlens array SB-MLA2, and a third individual microlens array SB-MLA3 having the same NA and focus distance, the microlens array 100 may be implemented to obtain three different NA or focus distances, based on the number of overlaps of first to third microlenses 120, 220, and 320.

Furthermore, the microlens array 100 according to the present invention may further include an n^{th} individual microlens array where the first to third individual microlens arrays SB-MLA1 to SB-MLA3 are stacked and an n^{th} microlens having the same focus distance is arranged on an n^{th} substrate.

Hereinafter, for convenience of description of the present invention, an example where the first to third individual microlens arrays SB-MLA1 to SB-MLA3 are stacked will be described.

To configure a multi-focus microlens array by using the skip-bound microlens array SB-MLA having the same NA and focus distance according to the present invention, the first to third individual microlens arrays SB-MLA1 to SB-MLA3 having the same NA and focus distance may be stacked.

Moreover, two skip-bound microlens arrays SB-MLAs of three skip-bound microlens arrays SB-MLA may be in the same line, and the other skip-bound microlens array SB-MLA may include a different number of overlapped microlenses 120, 220, and 320 through phase shift.

In detail, as illustrated in FIG. 4, the first to third individual microlens arrays SB-MLA1 to SB-MLA3 may be stacked for implementing a skip-bound microlens array for obtaining three different focus distances F1 to F3.

First, the second individual microlens array SB-MLA2 may be stacked on the first individual microlens array SB-MLA1, and the third individual microlens array SB-MLA3 may be stacked on the second individual microlens array SB-MLA2.

Moreover, the second individual microlens array SB-MLA2 of the stacked first to third individual microlens arrays SB-MLA1 to SB-MLA3 may be moved (i.e., phase-shifted) in a horizontal direction by a diameter of a microlens.

Therefore, when the number of overlaps of the first to third microlenses 120, 220, and 320 is changed, the NA and the focus distance F # may be changed in a traveling direction of light.

FIG. 5 is a cross-sectional view of a microlens array according to an embodiment of the present invention.

Referring to FIG. 5, the first to third individual microlens arrays SB-MLA1 to SB-MLA3 respectively including the first to third microlenses 120, 220, and 320 of the same array may be stacked.

Moreover, light irradiated in a direction of NA1 may be a singlet lens where one lens is provided, light irradiated in a direction of NA2 may be a doublelet lens where two lenses are provided, and light irradiated in a direction of NA3 may be a triplelet lens where three lenses are provided.

An array of the first to third microlenses 120, 220, and 320 having the same height and diameter may be designed so that NA1 has 0.02, NA2 has 0.037, and NA3 has 0.054.

In the design, an interval, a substrate thickness, and a medium characteristic of a microlens array may be reflected so that NA has 0.02, 0.054, and 0.037, based on optical design software, and thus, a shape and a focus distance of a beam may be calculated.

Such a design may have an optical effect where focus distances to a sensor are similar as an exit pupil (entrance pupil) of a thick dotted line illustrated in FIG. 5 is disposed near each of the first to third microlenses 120, 220, and 320.

Therefore, the present invention may stack the first to third individual microlens arrays SB-MLA1 to SB-MLA3 having the same NA and focus distance and may move (i.e., phase-shift) the second individual microlens array SB-MLA2 in a vertical or horizontal direction, and thus, the first individual microlens array SB-MLA1 may have a focus distance F1 which is longest and NA1 which is low, the second individual microlens array SB-MLA2 may have a focus distance F2 which is shorter than the focus distance F1 of the first individual microlens array SB-MLA1 and NA2 which is more than NA1, and the third individual microlens array SB-MLA3 may have a focus distance F3 which is shorter than the focus distance F2 based on stacking of the first individual microlens array SB-MLA1 and the second individual microlens array SB-MLA2 and NA3 which is more than NA2.

As described above, a plurality of (for example, three) NAs and focus distances may be implemented by stacking the first to third individual microlens arrays SB-MLA1 to SB-MLA3 where a different number of first to third microlenses 120, 220, and 320 overlap.

Moreover, the number of overlaps of the first to third microlenses 120, 220, and 320 may be adjusted by controlling the movements of the first to third individual microlens arrays SB-MLA1 to SB-MLA3, based on a use environment, and thus, the focus distances of the first to third individual microlens arrays SB-MLA1 to SB-MLA3 may be equal to one another.

Furthermore, a coating surface may be applied to one or some or all of the first to third individual microlens arrays SB-MLA1 to SB-MLA3.

FIG. 6 is an exemplary diagram of a microlens array form of an individual microlens array configuring a microlens array according to another embodiment of the present invention.

The microlens array according to another embodiment of the present invention, as in FIG. 6, may be implemented as individual microlens arrays are rotated vertically or horizontally, or overlap in the same direction.

For example, microlenses 120′, 220′, and 320′ may be arranged linearly, first to third individual microlens arrays SB-MLA1′ to SB-MLA3′ may be stacked in a vertical direction, and a position of the second individual microlens array SB-MLA2′, and thus, as illustrated in FIG. 6, a microlens array 100′ may be manufactured to have a form where a relatively thin dotted line represents a singlet lens where one lens is provided, a relatively thin solid line represents a doublelet lens where two lenses are provided, and a relatively thick solid line represents a triplelet lens where three lenses are provided.

In an embodiment of the present invention, three different multi-focuses may be implemented, but the present invention is not limited thereto and a microlens array may be manufactured by adjusting an array of microlenses in two or four or more multi-focuses.

FIG. 7 is a diagram illustrating an example where a stack-type microlens array according to an embodiment of the present invention is applied to a plenoptic camera.

A multi-focus plenoptic image obtaining device according to an embodiment of the present invention may include a main lens, an image sensor, and a microlens array.

The main lens may collect light from an object, and the image sensor may perform imaging of the light collected by the main lens.

Furthermore, the main lens may be replaced with an objective lens and a tube lens in a microscope, and in a general camera, the main lens may be replaced with an objective lens or a camera lens or a telephoto lens.

Moreover, when NA of the main lens has a value of about 0.15 to 0.065, a previously designed parameter may be applied, and a design value of a stack-type MLA may be changed based on the NA of the main lens.

Hereinafter, a microlens array for obtaining a multi-focus plenoptic image and a method of manufacturing the microlens array according to an embodiment of the present invention will be described with reference to the drawing.

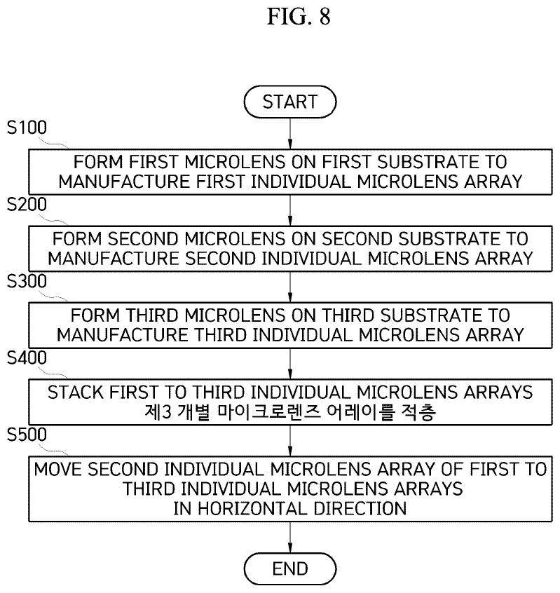

FIG. 8 is a flowchart illustrating a method of manufacturing a microlens array according to an embodiment of the present invention.

First, in step S100, a first individual microlens array may be manufactured by forming a first microlens having a first focus distance on a first substrate.

Moreover, in step S200, a second individual microlens array may be manufactured by forming a second microlens having a second focus distance on a second substrate.

Subsequently, in step S300, a third individual microlens array may be manufactured by forming a third microlens having a third focus distance on a third substrate.

Moreover, the first to third individual microlens arrays may be stacked in step S400.

At this time, the first individual microlens array may be disposed at a lowermost portion, the third individual microlens array may be disposed at an uppermost portion, and the second individual microlens array may be disposed between the first individual microlens array and the third individual microlens array.

As seen in a plane, the first to third individual microlens arrays manufactured through the process may be arranged in a form where two microlenses apart from each other by an interval corresponding to one microlens in a vertical/horizontal axis are configured as one pair.

When configured as described above, lights passing through the microlens array 100 having the same focus distance may have different phases and may substantially have different focus distances in a vertical direction.

That is, a substantial focus distance of a lens in light passing through three individual microlens arrays may be F3, a substantial focus distance of a lens in light passing through two individual microlens arrays may be F2, and a substantial focus distance of a lens in light passing through one individual microlens array may be F. Here, for convenience, equations may be expressed as F3, F2, and F1.

Also, in the present invention, the second individual microlens array of the first to third individual microlens arrays stacked as described above may be moved (i.e., phase-shifted) in a horizontal direction by a diameter of a microlens in step S500.

Such a step of manufacturing the first to third individual microlens arrays may be performed by a nano imprinting process.

Furthermore, in the microlens array according to the present invention, the first to third individual microlens arrays may be stacked, and an n^{th} individual microlens array where n^{th} microlenses having the same focus distance are arranged on an n^{th} substrate, but the present invention is not limited thereto.

Moreover, the first to third focus distances may differ, or may be equal to one another.

As seen in a plane, the first to third individual microlens arrays manufactured through the process may be arranged in a form where two microlenses apart from each other by an interval corresponding to one microlens in a vertical/horizontal axis are configured as one pair.

Each of the first to third individual microlens arrays having such a form according to the present invention may be referred to as a skip-bound MLA.

Furthermore, a coating surface may be applied to one or some or all of the first to third individual microlens arrays.

Hereinafter, an imprinting-based manufacturing process of a microlens array for obtaining a multi-focus plenoptic image according to an embodiment of the present invention will be described with reference to the drawing.

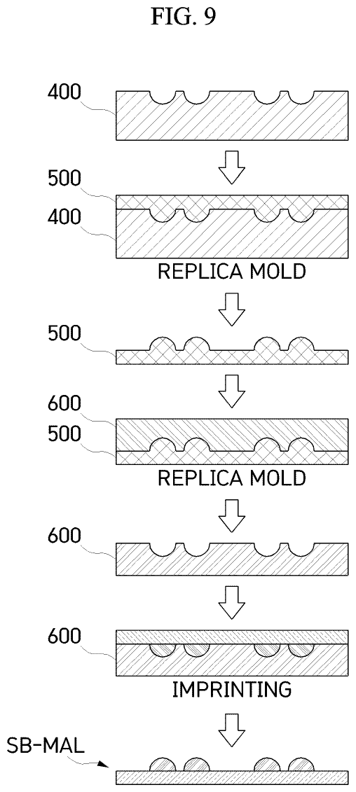

FIG. 9 is a schematic view illustrating an imprinting-based manufacturing process of a microlens array according to an embodiment of the present invention.

First, a microlens array metal mold 400 may be manufactured, and then, an RM311 mold 500 may be replicated through replica molding.

The replicated RM311 mold 500 may be replicated to a PDMS mold 600 through replica molding.

Moreover, a microlens array SB-MLA may be manufactured on glass through nano imprinting in the PDMS mold 600.

Furthermore, the reason that the replica mold is used twice may be because an imprinting process is limited, and thus, in a case which uses another process, a microlens array may be manufactured to be suitable for the other process.

Moreover, in an embodiment of the present invention, it has been described that first to third individual microlens arrays are manufactured by a nano imprinting process, but if the first to third individual microlens arrays may be effectively manufactured, the first to third individual microlens arrays may be manufactured by various processes, and a manufacturing process is not limited.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A microlens array for obtaining a multi-focus plenoptic image, the microlens array comprising:
a first individual microlens array where first microlenses having one focus distance are arranged on a first substrate;
a second individual microlens array where second microlenses having the same or different focus distances are arranged on a second substrate, the second individual microlens array being stacked on the first individual microlens array; and
a third individual microlens array where third microlenses having the same or different focus distances are arranged on a third substrate, the third individual microlens array being stacked on the second individual microlens array,
wherein, as seen in a plane, an array form of the first to third microlenses are configured with two microlenses, which are spaced apart from each other by an interval corresponding to one microlens in a vertical axis and a horizontal axis, on one of the first to third substrates.

2. The microlens array of claim 1, wherein the second individual microlens array is phase-shifted by a diameter of a microlens in one direction of a vertical direction and a horizontal direction.

3. The microlens array of claim 1, further comprising an n^{th} individual microlens array where n^{th} microlenses having the same focus distance are arranged on an n^{th} substrate, the n^{th} individual microlens array being stacked on the first to third individual microlens arrays.

4. The microlens array of claim 1, wherein focus distances of the first to third microlenses differ.

5. The microlens array of claim 1, wherein focus distances of the first to third microlenses are equal to one another.

6. The microlens array of claim 1, wherein a coating surface is provided in at least one of the first to third individual microlens arrays.

7. A method of manufacturing a microlens array for obtaining a multi-focus plenoptic image, the method comprising:
a step of forming a first microlens having a first focus distance on a first substrate to manufacture a first individual microlens array;
a step of forming a second microlens having a second focus distance on a second substrate to manufacture a second individual microlens array;
a step of forming a third microlens having a third focus distance on a third substrate to manufacture a third individual microlens array; and
a step of stacking the first to third individual microlens arrays.

8. The method of claim 7, wherein the first to third individual microlens arrays are manufactured by a nano imprinting process.

9. The method of claim 7, further comprising:
a step of forming an n^{th} microlens having an n^{th} focus distance on an n^{th} substrate to manufacture an n^{th} individual microlens array; and
a step of stacking the n^{th} individual microlens array on the first to third individual microlens arrays.

10. The microlens array of claim 7, wherein focus distances of the first to third microlenses differ.

11. The microlens array of claim 7, wherein focus distances of the first to third microlenses are equal to one another.

12. The method of claim 7, wherein array forms of first to third microlenses respectively arranged in the first to third individual microlens arrays are equal to one another.

13. The method of claim 7, further comprising a step of forming a coating surface in at least one of the first to third individual microlens arrays.

14. A multi-focus plenoptic image obtaining device comprising:
a main lens configured to collect light from an object;
an image sensor configured to perform imaging of the light collected by the main lens;
a first individual microlens array where a first microlens having a first focus distance is arranged, the first individual microlens array being disposed between the main lens and the image sensor;
a second individual microlens array where a second microlens having a second focus distance is arranged, the second individual microlens array being stacked on the first individual microlens array; and
a third individual microlens array where a third microlens having a third focus distance is arranged, the third individual microlens array being stacked on the second individual microlens array,
wherein a microlens array including the first to third individual microlens arrays transfers the light, collected by the main lens, to the image sensor at a plurality of different focus distances.

15. The multi-focus plenoptic image obtaining device of claim 14, wherein the microlens array further comprises an n^{th} individual microlens array where n^{th} microlenses having the same focus distance are arranged on an n^{th} substrate, the n^{th} individual microlens array being stacked on the first to third individual microlens arrays.
